(19) United States
(12) Patent Application Publication
(10) Pub. No.: US 2007/0143000 A1
(43) Pub. Date: Jun. 21, 2007

(54) Wireless Spark Energy Indicator

(76) Inventors: Trevor Scott Bryant, Sault Ste. Marie (CA); Ronald Matthew Lusterio, Sault Ste. Marie (CA)

Correspondence Address: Ron Lusterio, 143 Upton Road, Sault Ste. Marie, ON, P6A-3W2, US

(21) Appl. No.: 11/306,136

(22) Filed: Dec. 16, 2005

(51) Int. Cl. G06F 19/00; B60Q 1/00; G06G 7/70

(52) U.S. Cl. 701/114; 701/115; 340/439

(57) ABSTRACT

A process which wirelessly detects spark activity and by using software and a microcontroller to process the data share the information with other devices or information networks

This invention simply detects the presence of spark energy and indicates said presence of spark energy with a light emitting diode (LED) or by sending the information wirelessly or otherwise to any other device or information network.

This invention does not analyze spark ignition or engine operation as indicated in prior art. Also, this invention does not diagnose whether or not spark plugs are firing properly only that the spark plug or plugs fire at all. The information that is processed by this device may be easily shared or interfaced with any other device or information network. This invention is a small simple device that indicates the presence of spark activity in a spark-producing object such as a spark plug, without requiring physical contact with that object.

This invention provides a convenient way to know immediately if a spark plug is firing, misfiring or has fired (in the case of a non-running engine) inside a motor without touching the engine. This invention does not analyze the spark or ignition system of a gas engine as is claimed in previous prior art (U.S. Pat. No. 5,194,813). This invention simply indicates that spark is present or not present and has the ability to share this information by interfacing to any other computing device or information network.

In addition, the antenna performs a new purpose. Not only does it receive the spark signal, it also acts as a high intensity flashlight that illuminates the dark reaches of engine compartments so the user may safely and clearly see the target spark plug.

### BACKGROUND

It is ironic that there are other devices previously invented that claim to “test” for spark however they only check for high voltage only and they require inline hookup (non-wireless). Examples can be found in U.S. Pat. Nos. 6,064,211; 4,156,839; and 4,384,256.

The irony is that the presence of high voltage going to the spark plug boot does not guarantee that there is spark present and emitting from the end of the spark plug that is inside the engine. Not only does our invention perform real spark energy detection, because it is software based, it has the ability to share this information by interfacing with other computing devices or information networks. Our invention is also designed to detect high voltage at the same time providing added value.

There is one other U.S. patent that exists (U.S. Pat. No. 5,194,813) and although it is portable and claims to analyze spark ignition, it is not software controlled and therefore cannot share the information by interfacing to any other computing device or information network. It also is not designed with safety in mind. Our invention is specifically designed to be user friendly, functionally safe due to a safety detachable antenna and for use in dark or lowlight situations. The tip of the antenna that is used to probe inside an engine compartment also contains a high intensity LED flashlight. Our improvement also allows the spark detection to be shared or other software enhancements to be made.

This may be considered a safe design because probing around inside a dark engine compartment with a running motor inside can be a hazardous undertaking. Also, because the detachable antenna picks up the spark signal wirelessly, there is much less risk of electrical shock hazard. The antenna in our invention is designed to detach before potentially harming the operator.

This device is an improvement over any previous invention because it: is versatile and more reliable by using a small microcontroller (computer) with embedded software to process the information is capable of sharing the processed information with other devices or information networks actually detects spark activity not just high voltage uses wireless signal detection fewer electronic components than any previous invention (due to software) has been designed with safety in mind, uses detachable antenna is small enough for a shirt pocket is ergonomic, easy to hold in one hand and less awkward can use different types of antennas for different situations allows the user to use it easily at night or in dark engine compartments

### RELEVANT PRIOR ART INCLUDES

### U.S. Patents

U.S. Pat. No. 3,286,165 November, 1966 Small 324/391
U.S. Pat. No. 4,004,213 January, 1977 Kato 324/399
U.S. Pat. No. 4,006,403 February, 1977 Olsen 324/399
U.S. Pat. No. 4,008,434 February, 1976 Schaefer 324/381
U.S. Pat. No. 4,684,896 August, 1987 Weishaupt 324/399
U.S. Pat. No. 4,937,527 June, 1990 Sniegowski 324/384
U.S. Pat. No. 5,194,813 March, 1993 Hannah et al.

### Foreign Patent Documents:

CA 2,065,123-7 Dec., 1995

EU 92,810,660.8 March, 1993

### Field of Search

73/116
117.30
324/402
399
392
391
379
380

### ADVANTAGES

One advantage of this invention is that it saves valuable time by identifying a non-firing spark plug immediately. When a gas engine does not start, this invention will immediately indicate if the spark plug even fired once inside the engine without touching the engine. Since the only requirements for a gas engine to start are spark, fuel and oxygen, no time is wasted wondering if spark is the problem. Oxygen is assumed to be present so it points the trouble source towards something fuel-related. This extremely useful for a crew in a racing pit stop.

Another big advantage of this invention is that it allows the decision to be made to replace only the bad spark plug(s), increasing overall engine performance and fuel efficiency. It does this by allowing the discovery of the misfiring spark plug(s) safely and immediately. It will perform this function without touching or removing the bad spark plug(s).

Misfiring plugs are a known cause of inefficient fuel consumption and premature engine wear. Removing a spark plug from a hot engine just to check it, may result in damaging the threads of the engine head which is usually made of aluminum. This invention saves from having to remove or touch the spark plug or spark plug wire just to check the spark plug for spark activity.

Another advantage of this invention is that there is no special knowledge or training required to use it. It is simple to operate, requiring only the pressing of an “ON” button. If the light is on, there is spark present. If there is no light, there is no spark present. The device will shut off by itself after 5 minutes of being idle.

### OPERATION

This invention is controlled by embedded software on the computer chip. It detects the wireless radio frequencies (RF) emitted by spark and indicates the presence of spark with an LED light. It is simple to use, there is one button to power the device on. It is now automatically in ‘Real Time’ mode. With the antenna plugged securely into the device, the tip of the antenna is brought near the target spark plug boot. The spark indicator light will flash if there is spark present from the target spark plug inside the cylinder. The built-in self diagnostic routine ensures tool is fully functional; it is accessed on an as-needed basis. The software can easily integrate with other IP based computing devices or information networks.

There are three modes of software operation:

Real Time Mode

Allows for instant readings with each pulse of energy that occurs in a spark plug wire. This is the default setting once the device is powered on.

Snap Shot Mode

Allows the last reading to be ‘memorized’ until the user clears it. (Useful if the user cannot be near the engine when the engine is being started)

Diagnostic Mode

Allows the user to acknowledge that the unit is functioning properly.

### DRAWINGS-FIGURES

FIG. 1—ERGONOMIC HOUSING

FIG. 1 Reference Numerals:
1(a)—top view
1(b)—front view
1(c)—side view
1(d)—back view (x-ray)
1(e)—side view (x-ray)
1(f)—battery cover
10—hourglass contoured shape
12—reinforced antenna jack
14—protective overlay
16—matt finish on led lenses
18—non-slip handgrip surface on contour
20—laminated overlay
22—front half
24—back half
26—rounded edges
28—battery opening
30—high impact plastic
32—secure screw (top half/bottom half)
34—secure screw (battery cover)
36—battery cover
38—secure tabs
40—positive spring contacts

FIG. 2—Main Circuit Board Schematic

FIG. 3—General Antenna

FIG. 3 Reference Numerals
44—antenna finger grip
46—antenna probe end assembly
48—wire hook
50—wire coupler
52—thumb opener
54—antenna cable
56—high intensity LED
58—antenna plug
60—alignment shaft

FIG. 4—Software Flowchart

FIG. 4(a)—Initial Power Up

FIG. 4(b)—General Operation

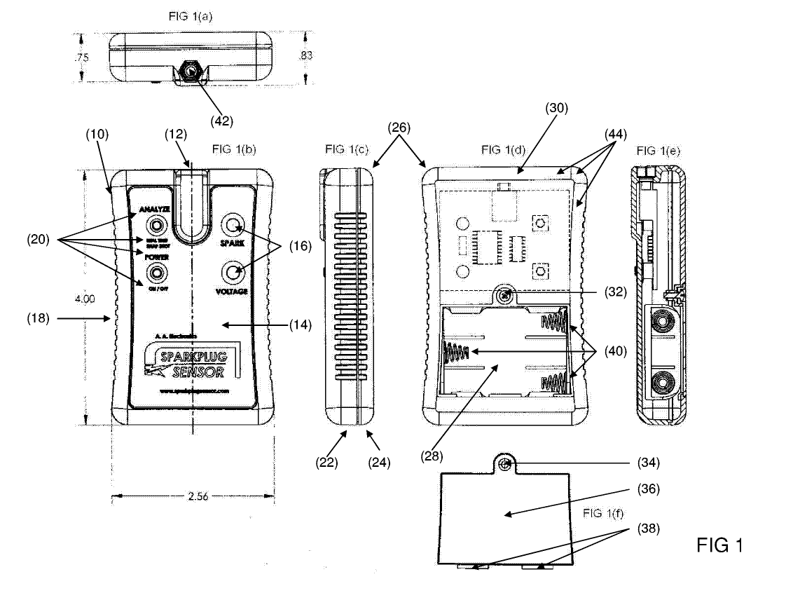

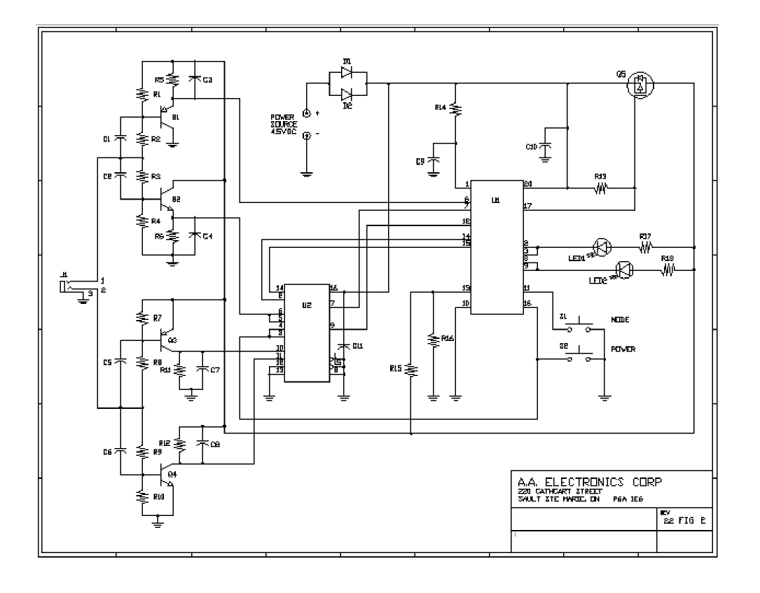

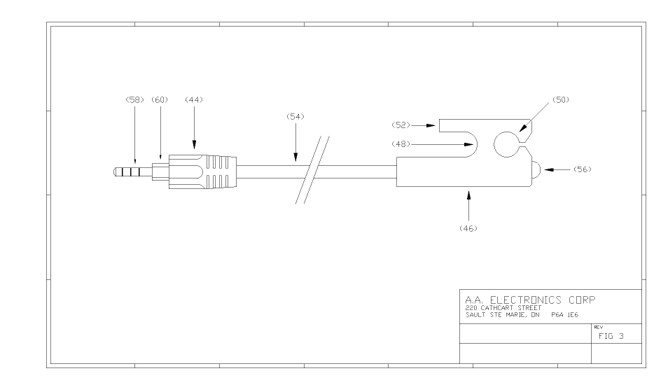

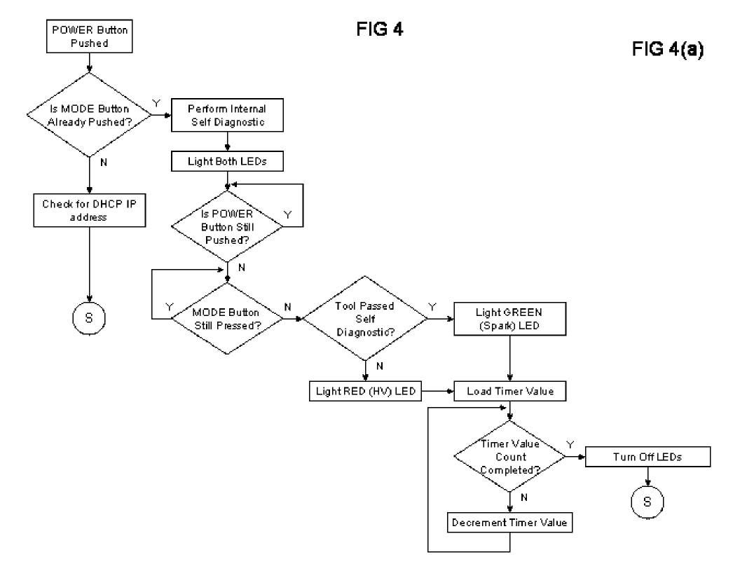

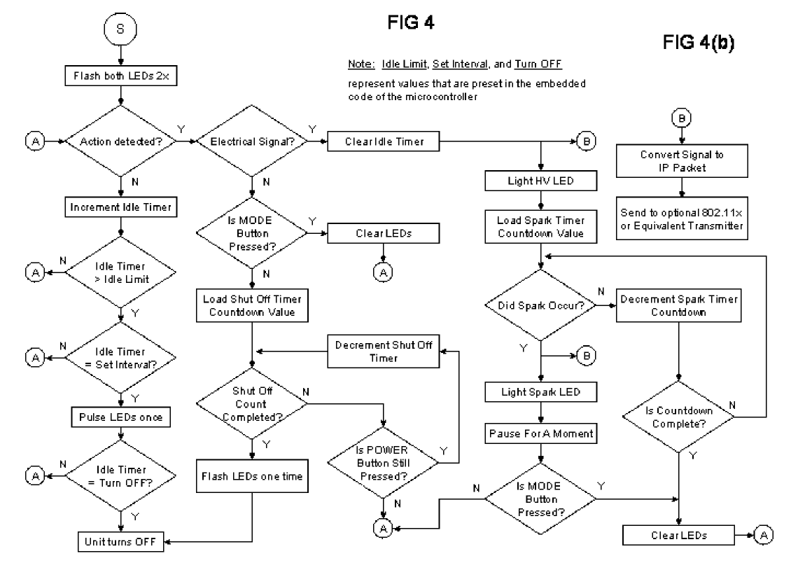

### USER INTERFACE

The user interface consists of two momentary contact switches (Power and Mode). There is one high intensity red LED lamp that indicates the presence of high voltage. There is one high intensity blue LED that indicates the presence of spark activity. Both switches and both LEDs are behind a protective overlay.

### Alternative Embodiments

Computer and Software

The microcontroller can be replaced with any suitable processor replacement capable of responding to the voltage and spark signals in the required time frames. The flash pattern of the LEDs on Power Up, Power Down, and Diagnostic Mode can be altered in the software or removed to suit the needs of the client. The LEDs can be changed to other colors and brightness's. The information may be easily shared with other computing devices or information networks.

Antenna

The safety detachable antenna can be any electrically insulated two conductor wire with the tip of the antenna being anything non-conductive to protect the two exposed wires (exposed meaning not shielded electrically). It has a built-in bright white LED light in the tip to illuminate dark engine compartments. The antenna has rigidity but is pliable enough and can be bent into position to get around obstacles. The user can replace the antenna with one such as a solid, fixed length, non-bendable antenna better suited for specific applications.

The end of the antenna that picks up the wireless signal is used to couple onto the plug wire, hook onto the plug wire, or just come near to the plug wire.

Housing

The device housing is made of plastic but can be made of any material. The specially designed hex hole for the antenna can be any shape to prevent rotation of the antenna. The two halves of the case can be sonic welded instead of being screwed together. The housing or case can be made of a different plastic to withstand harsher environments. Different colors can be used for the case.

Circuitry

The circuit is based around any suitable microcontroller. Uses only two ICs (the microcontroller and an electronic switch). All components are surface mount (except the battery holder connections). LEDs are high intensity and are located behind a matte finish overlay this allows easy viewing in direct sunlight. The LEDs can be any color with appropriate current limiting in place. Reverse battery protection is built-in electronically.

What is claimed is:

1. An improved method of wirelessly detecting and conveying the presence of spark energy simply, and efficiently comprising
a) the use of any suitable microcontroller possessing sufficient performance requirements to process the said spark energy data
b) the ability to easily interface the resulting information with other devices or information networks using wireless or non-wireless means
Wherein the improvement comprises the use of software code to process the signal, perform intelligent self diagnostic tests to ensure reliability of operation and whereby the resulting processed information directly and efficiently signifies the presence of spark; and that same information may be easily interfaced to any other device or information network through wired or wireless transmission means.

2. A new use for the antenna or probe comprising
a) an embedded super bright light emitting diode (LED) with a quick release safety detachable connector.
